(19) United States
(12) Patent Application Publication
(10) Pub. No.: US 2013/0068877 A1
(43) Pub. Date: Mar. 21, 2013

(54) BOTTOM-ADJUSTABLE PROPELLER-TYPE FLYING OBJECT

(71) Applicants: Key Dong Choi, Seoul (KR); Key Nam Choi, Seoul (KR)

(72) Inventors: Key Dong Choi, Seoul (KR); Key Nam Choi, Seoul (KR)

(73) Assignee: SUNTECH ENTERPRISES, Seoul (KR)

(21) Appl. No.: 13/700,649

(22) PCT Filed: May 3, 2011
(86) PCT No.: PCT/KR2011/003295

§ 371 Date: Nov. 28, 2012

(30) Foreign Application Priority Data
Jun. 1, 2010 (KR) 10-2010-0051563

(51) Int. Cl. B64C 27/82

(52) U.S. Cl. CPC B64C 27/82
USPC 244/17.19

(57) ABSTRACT

An existing bottom-adjustable propeller-type flying object requires a device having a complex structure constructed through the combination of various components such as a servo, a control plate, and a hinge to control the rotor pitch at every moment and operate an adjustable blade for flight control. The bottom-adjustable propeller-type flying object of the disclosure includes a circular frame with a fixing plate and a protective plate installed at a lower portion of a shaft of a power propeller mounted to the central shaft, and an adjusting motor having an adjustable propeller. The flying object moves up or down by using force of the wind generated downward due to the rotation of the power propeller. The flying object makes a hovering flight, and leftward, rightward, forward, and backward flights by using the force of the wind generated due to the rotation of the adjustable propellers mounted on two adjusting motors.

### TECHNICAL FIELD

The present invention relates to a bottom-adjustable propeller-type flying object. In more particular, the present invention relates to a bottom-adjustable propeller-type flying object acting as a flying object having small bottom blades, which is one type of an unmanned rotor craft.

### BACKGROUND ART

In general, a bottom-adjustable propeller-type flying object according to the related art includes a rotor or a propeller, which rotates about the central shaft of the flying object by a driving force, a power part, a controller, a fixing plate, and adjustable blades. The bottom-adjustable propeller-type flying object makes a flight by operating an adjustable blade for the removal of anti-torque provided at the lower portion of the propeller.

The bottom-adjustable propeller-type flying object according to the related art maintains the balance thereof by adjusting the pitch of the rotor using a sensor or a stable bar whenever the bottom-adjustable propeller-type flying object loses the balance thereof, includes an adjustable blade crossing a shaft under the body of the flying object in order to make the hovering flight, the forward and backward flights, and the leftward and rightward flights, or includes an adjustable blade for the forward and backward flights or an adjustable blade for the leftward and rightward flights separately installed under the flying object. The bottom-adjustable propeller-type flying object according to the related art has a complex structure and complex adjusting devices, and represents low power efficiency due to the variation of the pitch angle of the rotor.

In addition, a bottom-adjustable blade-type flying object according to the related art, in which an adjustable blade is installed under the body thereof by using a fixed pitch propeller, has a complex structure including a servo, a control plate, and a hinge in order to adjust the adjustable blade, and the hinge used to mount the control plate and the adjustable blade is exposed. Accordingly, the bottom-adjustable blade-type flying object according to the related art may be easily broken and may have a disadvantage in the management thereof. In addition, the volume and the weight of the bottom-adjustable blade-type flying object are increased due to the combination of several components, so that the power efficiency is degraded.

### DISCLOSURE

### Technical Problem

Accordingly, the present invention has been made keeping in mind the above problems occurring in the prior art, and an object of the present invention is to provide a bottom-adjustable propeller-type flying object having a simple structure and simple devices instead of a device which necessarily adjusts the pitch of a rotor at each moment and has a complex structure formed through the combination of several components, such as a servo, a control plate, and a hinge, to operate an adjustable blade.

### Technical Solution

In order to accomplish the objects, according to one aspect of the present invention, there is provided a bottom-adjustable propeller-type flying object. The bottom-adjustable propeller-type flying object includes a central shaft having a shape of a hollow cylindrical pipe, a power propeller fitted around an outer circumference of the central shaft, equipped with an external gear, and having a plurality of blades, a power unit mounted on an upper portion of the central shaft and including a power source to generate power and a power motor operated by the power source, a power gear fixedly mounted on a shaft of the power motor and engaged with the external gear, a controller mounted on a lower portion of the central shaft and including a control unit, a circular frame having a shape of a circular ring, a fixing plate having a shape of a rectangular plate with a bent middle lower portion, an adjusting motor on which an adjustable propeller having a plurality of blades is fixedly mounted, a protective plate having a shape of a rectangular plate with a middle portion into which the adjusting motor is inserted, and a plurality of leg plates having a shape of a bent rectangular plate and attached to a lower portion of the circular frame in a longitudinal direction while being spaced apart from each other by a predetermined distance. One end of the fixing plate and one end of the protective plate are fixedly mounted to inner middle portions of the circular frame and the leg plates in a longitudinal direction while being alternately aligned clockwise such that the fixing plate and the protective plate form a cross shape. An opposite end of the fixing plate and an opposite end of the protective plate are fixedly mounted to an outer portion of the controller in a longitudinal direction. Wirings of the power unit and the control unit are connected to each other through an inner part of the central shaft. Functions of anti-torque, hovering flight, leftward or rightward rotation, and forward or backward flight of the bottom-adjustable propeller-type flying object are performed by using wind generated downward by rotation of the power propeller and wind generated by rotation of the adjustable propeller.

In addition, according to the bottom-adjustable propeller-type flying object of the present invention, a portion of the anti-torque caused in the bottom-adjustable propeller-type flying object due to the rotation of the power propeller is removed by the fixing plate, and the hovering flight, the leftward or rightward rotation, and the forward or backward flight of the bottom-adjustable propeller-type flying object are performed by force of wind generated as the adjustable motor is operated.

Further, according to the bottom-adjustable propeller-type flying object of the present invention, devices and parts of the bottom-adjustable propeller-type flying object are configured to allow a center of gravity of the bottom-adjustable propeller-type flying object to be positioned in vicinity of a middle portion of the central shaft making contact with the power propeller.

Further, according to the bottom-adjustable propeller-type flying object of the present invention, the leg plates protect first and second fixing plates, first and second protective plates, and first and second adjustable propellers, and deliver wind to the first and second fixing plates and the first and second protective plates when the bottom-adjustable propeller-type flying object is landed on or taken off.

In addition, according to the bottom-adjustable propeller-type flying object of the present invention, the protective plate divides the wind generated downward by the rotation of the power propeller to allow the wind to pass therethrough, and protects the adjustable propeller and the adjusting motor.

### Advantageous Effects

As described above, according to the present invention, the bottom-adjustable propeller-type flying object can control the anti-torque, make the hovering flight, the leftward and rightward rotation, and the forward and backward flights by using two adjusting motors having adjustable propellers mounted thereon.

In addition, according to the present invention, the failure and the breakdown caused by the combination of several components of a flying object according to the related art can be reduced by simplifying the structure and the adjustment of the bottom-adjustable propeller-type flying object. In addition, since the size and the weight of the bottom-adjustable propeller-type flying object can be reduced, the power efficiency of the bottom-adjustable propeller-type flying object can be enhanced. Further, the duration of the flight of the bottom-adjustable propeller-type flying object can be increased.

### DESCRIPTION OF DRAWINGS

FIG. 1 is a perspective view showing a bottom-adjustable propeller-type flying object according to the present invention;

FIG. 2 is a longitudinal sectional view of FIG. 1 to schematically show the present invention;

FIG. 3 is a partially-cut perspective view of the bottom-adjustable propeller-type flying object according to the present invention of FIG. 1; and

FIG. 4 is a top view schematically showing the partially-cut view to explain the flying method of the present invention.

### BEST MODE

### Mode for Invention

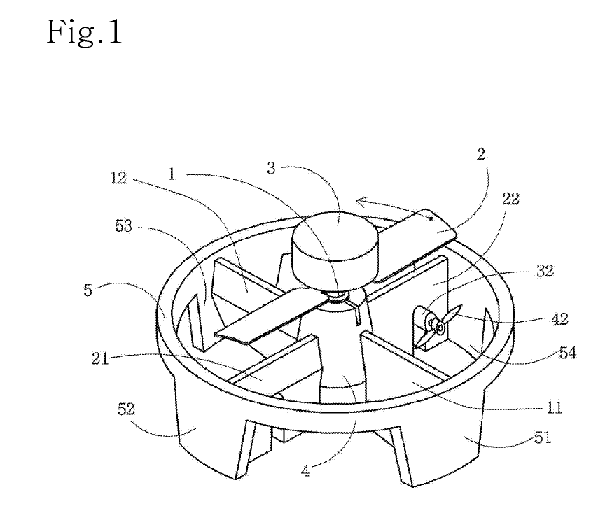

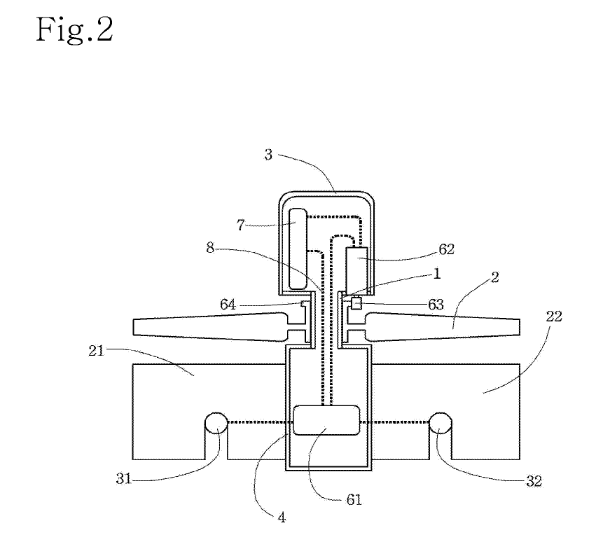

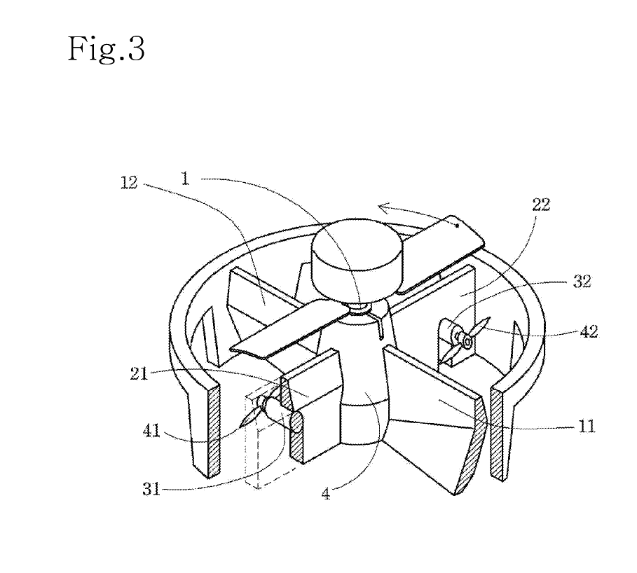

Hereinafter, in order to accomplish the above object, the structure of the present invention will be described with reference to FIG. 1, which is a perspective view of the present invention, FIG. 2, which is a longitudinal sectional view of FIG. 1 without a circular frame 5 and leg plates 51, 52, 53, and 54 of FIG. 1, and FIG. 3 which is a partially-cut perspective view of FIG. 1.

A bottom-adjustable propeller-type flying object according to the present invention includes a fixed pitch power propeller 2 mounted on an outer circumference of a central shaft 1 having the shape of a hollow cylindrical pipe and having a plurality of blades, a power unit 3 mounted on the upper portion of the central shaft 1, a controller 4 mounted on the lower portion of the central shaft 1, first and second fixing plates 11 and 12, first and second protective plates 21 and 22, a circular frame 5 having the shape of a circular ring, leg plates 51, 52, 53, and 54, and first and second adjustable propellers 41 and 42 having a plurality of blades mounted on shafts of first and second adjusting motors 31 and 32. One ends of the first and second fixing plates 11 and 12 and one ends of the first and second protective plates 21 and 22 are fixedly attached to an outer portion of the controller 4 in a longitudinal direction while crossing each other. In addition, opposite ends of the first and second fixing plates 11 and 12 and opposite ends of the first and second protective plates 21 and 22 are fixedly attached to the circular frame 5 and the leg plates 51, 52, 53, and 54, respectively. The first and second adjusting motors 31 and 32 are buried in the first and second protective plates 21 and 22, respectively, and the power unit 3 includes a power motor 62 equipped with a power gear 63 and a power source 7. The controller 4 includes a control unit 64. In addition, an external gear 64 including a spur gear is fixedly mounted on the center of the shaft of the fixed pitch power propeller 2 in such a manner that the external gear 64 is engaged with the power gear 63 including a spur gear installed in the power motor 62. The power unit 3 is electrically connected to a device of the controller 4 through a connection line 8 passing through the inner part of the central shaft 1. Meanwhile, the bottom-adjustable propeller-type flying object according to the present invention is provided in such a manner that the center of the gravity is provided near the central portion of the central shaft 1 of the fixed pitch power propeller 2. In other words, all components of the flying object are arranged in such a manner that the weight of the upper device of the fixed pitch power propeller 2 is equal to the weight of the lower device of the fixed pitch power propeller 2.

In the present structure, since the central shaft 1 having the shape of a hollow cylindrical pipe, which serves as a shaft of the fixed pitch power propeller 2 having the external gear 64 attached thereto, has an empty inner part, the central shaft 1 is used as the passage of the connection line 8 to connect the power unit 3 of the flying object to the controller 4. The central shaft 1 is provided at the outer circumference thereof with the fixed pitch power propeller 2. The fixed pitch power propeller 2 is provided at the central portion thereof with the external gear 64 having a perforated central portion and a plurality of blades such that the external gear 64 can be operated by the power motor 62.

The circular frame 5 is a frame of the bottom-adjustable propeller-type flying object having the shape of a circular ring such that the wind generated due to the rotation of the fixed pitch power propeller 2 is smoothly transferred downward. The circular frame 5 has the first and second fixing plates 11 and 12, the first and second protective plates 21 and 22, and the leg plates 51, 52, 53, and 53 which are fixedly attached thereto. The circular frame 5 may be integrally provided with the leg plates 51, 52, 53, and 53.

FIG. 3 is a perspective view showing the bottom-adjustable propeller-type flying object according to the present invention by partially cutting the circular frame 5, the leg plates 51 and 52, and the first protective plate 21 of FIG. 1 for the illustrative purpose, and shows the structure of the first adjusting motor 31 and the first fixing plate 11 mounted on the first protective plate 21 in detail.

The first and second fixing plates 11 and 12 have lower portions bent in directions opposite to each other, and divide wind generated downward due to the rotation of the fixed pitch power propeller 2 to remove a portion of the torque of the flying object. The lower portion of each fixing plate has the shape of a rectangular plate bent in the direction opposite to the rotational direction of the fixed pitch power propeller 2 so that the wind generated downward due to the rotation of the fixed pitch power propeller 2 collides with the lower portion of the fixing plate to pass under the fixing plate.

The first and second protective plates 21 and 22 have a rectangular plate such that the wind generated downward due to the rotation of the fixed pitch power propeller 2 is divided while passing the first and second protective plates 21 and 22, the first and second adjusting motors 31 and 32 are inserted into the middle portions of the first and second protective plates 21 and 22, respectively, and the first and second adjustable propellers 41 and 42 are fixedly mounted on the first and second adjusting motors 31 and 32, thereby minimizing the breakdown of the first and second adjusting motors 31 and 32 caused by the external environments to protect the first and second adjusting motors 31 and 32.

The first and second adjusting motors 31 and 32 are independently adjusted by the control unit of the controller 4.

The leg plates 51, 52, 53, and 54 protect the first and second fixing plates 11 and 12, the first and second adjustable propellers 41 and 42, and the first and second protective plates 21 and 22 and smoothly transfer the wind generated due to the rotation of the fixed pitch power propeller 2 downward when the flying object is taken off or landed on. The leg plates 51, 52, 53, and 54 have the shape of a rectangular plate bent along the circular frame 5.

In this case, the position of the power unit 3 may be exchanged with the position of the controller 4 according to the balance of the weights of the power unit 3 and the controller 4 and the design of the power unit 3 and the controller 4, such that the center of the gravity of the flying object is provided near the fixed pitch power propeller 2 and the central shaft 1. In addition, both of the power unit 3 and the controller 4 may be mounted on the fixed pitch power propeller 2 according to the weight and the design of components.

According to the present invention, in order to easily achieve the balance stabilization of the flying object by using only the fixed pitch propeller without using a stabilizer bar and a variable pitch rotor, the weights of the devices are distributed so that the upper weight of the flying object is equal to the lower weight of the flying object about the central shaft 1 of the fixed pitch power propeller 2 as shown in FIG. 1, thereby achieving the balance stabilization of the flying object.

The fixed pitch power propeller 2 according to the present invention serving as a rotation body has a force to always maintaining the horizontal balance during the rotation of the fixed pitch power propeller 2. In this regard, according to the present invention, the balance stabilization of the flying object is basically maintained by using the restoring force which is the force of maintaining the horizontal balance.

Therefore, if the weight of the flying object is distributed into the upper and the lower portion thereof such that the center of the gravity of the flying object is provided in the vicinity of the horizontal center of the fixed pitch power propeller 2, the flying object can be stabilized with the less restoring force, and the power loss can be reduced by using the fixed pitch propeller when comparing with the variable pitch propeller.

Hereinafter, the operating principle of the flying object according to the present invention will be described. The control unit 61 controls the power motor 62 to receive the power through the connection line 8 connected to the power source 7. As the power gear 63 fixed onto the shaft of the power motor 62 is rotated, the external gear 64 engaged with the power gear 63 is simultaneously rotated. Accordingly, the fixed pitch power propeller 2 is rotated, so that the flying object makes a flight. In addition, the first and second adjusting motors 31 and 32 are operated to adjust the force of the wind generated from the first and second adjustable propellers 41 and 42, so that the flying object can make the hovering flight, forward and backward flights, and rotates leftward and rightward.

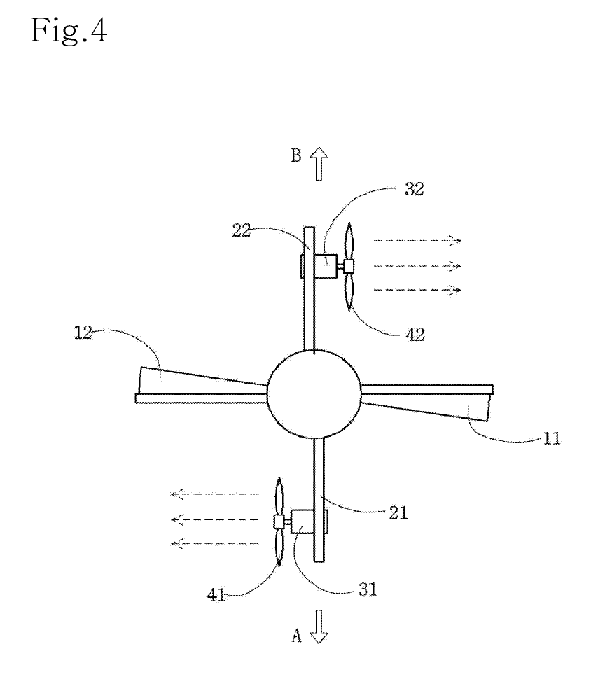

FIG. 4 is a schematic top view showing the structure of the controller 4, the first and second adjusting motors 31 and 32, and the first and second fixing plates 11 and 12 without upper devices including the fixed pitch power propeller 2, the circular frame 5, and the leg plates 51, 52, 53, and 54, which are shown in FIG. 1, to explain the flying principles of the hovering flight, the leftward rotation, the rightward rotation, the forward flight, and the backward flight of the bottom-adjustable propeller-type flying object.

Hereinafter, the flying principle according to the present invention will be described with reference to FIGS. 1 and 4. If the fixed pitch power propeller 2 is rotated counterclockwise by operating the power motor 62 in the structure in which the power source 7, such as a battery, included in the power unit 3 and the power motor 62 are connected to the control unit 61 included in the controller through wirings, the bottom-adjustable propeller-type flying object moves up by the trust of the wind generated downward due to the rotation of the fixed pitch power propeller 2 to make a flight. Simultaneously, the bottom-adjustable propeller-type flying object rotates clockwise by the anti-torque resulting from the rotation movement of the fixed pitch power propeller 2.

Regarding the torque of the flying object generated as the fixed pitch power propeller 2 is rotated, the first and second fixing plates 11 and 12 receive the wind generated downward due to the rotation of the fixed pitch power propeller 2 to remove a portion of the torque, and the remaining portion of the torque adjusts the rotational speeds of the first and second adjusting motors 31 and 32, thereby controlling the torque of the flying object by using the force of the wind generated from the first and second adjustable propellers 41 and 42, so that the flying object can make the hovering flight, forward and backward flights, and rotates leftward and rightward.

In addition, on the assumption that the direction of an arrow A indicating the downward direction of FIG. 4 is defined as the forward direction of the flying object, and the direction of an arrow B indicating the opposite direction to the downward direction is defined as the backward direction of the flying object, the rotational speeds of the first and second adjusting motors 31 and 32, which are two adjusting motors, are differently and independently adjusted by the control unit 61. In this case, if the rotational speed of the first adjustable propeller 41 is greater than that of the second adjustable propeller 42, the flying object makes a forward flight due to the gyro procession effect. If the rotational speed of the first adjustable propeller 41 is less than that of the second adjustable propeller 42, the flying object makes a backward flight.

Therefore, according to the present invention, the flying object moves up or down by the force of the wind generated as the fixed pitch power propeller 2 is rotated. In addition, as the two adjusting motors 31 and 32 are operated, the force of the wind is generated from the first and second adjustable propellers 41 and 42 mounted on the adjusting motors 31 and 32, and the anti-torque control, the hovering flight, leftward and rightward rotation, and forward and backward flights of the flying object may be performed by the force of the wind generated from the first and second adjustable propellers 41 and 42. Accordingly, the flying object can be simply adjusted, and the breakdown and the damage of the flying object caused through the combination of several components, such as the servo, the control plate and the hinge, according to the related art can be reduced. In addition, the structure of the flying object is simplified, so that the size and the weight of the flying object can be reduced. Therefore, the power efficiency can be increased, and the duration of the flight of the flying object can be increased.

The accompanying drawing of the present invention is provided only for the illustrative purpose such that those skilled in the art can easily comprehend the present invention, and the top surface of the circular frame 4, the top surfaces of the first and second fixing plates 11 and 12, and the top surfaces of the first and second protective plates 21 and 22 are manufactured in the streamlined shape to least receive the resistance of the wind.

The detailed wiring scheme of parts and components follows a typical wiring scheme to operate the flying object, and the details of the wiring scheme will be omitted in order to avoid redundancy.

In addition, the parts and the devices according to the present invention include various materials such as plastic, an iron plate, and an EPP foam. Accordingly, the details of schemes of mounting and fixing the parts and the components will be omitted, and the parts and the components are mounted and fixed through a welding scheme, a fitting scheme, and an adhesive.

Although the bottom-adjustable propeller-type flying object according to the exemplary embodiments of the present invention have been described, it is understood that the present invention should not be limited to these exemplary embodiments but various changes and modifications can be made by those skilled in the art within the spirit and scope of the present invention as hereinafter claimed.

1. A bottom-adjustable propeller-type flying object serving as a small unmanned rotor craft, the bottom-adjustable propeller-type flying object comprising:
a central shaft having a shape of a hollow cylindrical pipe;
a power propeller fitted around an outer circumference of the central shaft, equipped with an external gear, and having a plurality of blades;
a power unit mounted on an upper portion of the central shaft and including a power source to generate power and a power motor operated by the power source;
a power gear fixedly mounted on a shaft of the power motor and engaged with the external gear;
a controller mounted on a lower portion of the central shaft and including a control unit;
a circular frame having a shape of a circular ring;
first and second fixing plates having shapes of rectangular plates with bent middle lower portions;
first and second adjusting motors on which first and second adjustable propellers having a plurality of blades are fixedly mounted, respectively;
first and second protective plates having shapes of rectangular plates with middle portions into which the first and second adjusting motors are inserted, respectively; and
a plurality of leg plates having a shape of a bent rectangular plate and attached to a lower portion of the circular frame in a longitudinal direction while being spaced apart from each other by a predetermined distance,
wherein one end of each of the first and second fixing plates and one end of each of the first and second protective plates are fixedly mounted to inner middle portions of the circular frame and the leg plates in a longitudinal direction while being alternately aligned clockwise such that the first and second fixing plates and the first and second protective plates form a cross shape,
an opposite end of each of the first and second fixing plates and an opposite end of each of the first and second protective plates are fixedly mounted to an outer portion of the controller in a longitudinal direction,
wirings of the power unit and the control unit are connected to each other through an inner part of the central shaft,
rotational speeds of the first and second adjusting motors are independently controlled by the control unit such that the rotational speed of the first adjusting motor is different from the rotational speed of the second adjusting motor, and
functions of anti-torque, hovering flight, leftward or rightward rotation, and forward or backward flight of the bottom-adjustable propeller-type flying object are performed by using wind generated downward by rotation of the power propeller and wind generated by rotation of the first and second adjustable propellers.

2. The bottom-adjustable propeller-type flying object of claim 1, wherein a portion of the anti-torque caused in the bottom-adjustable propeller-type flying object due to the rotation of the power propeller is removed by the first and second fixing plates, and the hovering flight, the leftward or rightward rotation, and the forward or backward flight of the bottom-adjustable propeller-type flying object are performed by force of wind generated as the first and second adjusting motors are operated.

3. The bottom-adjustable propeller-type flying object of claim 1, wherein devices and parts of the bottom-adjustable propeller-type flying object are configured to allow a center of gravity of the bottom-adjustable propeller-type flying object to be positioned in vicinity of a middle portion of the central shaft making contact with the power propeller.

4. The bottom-adjustable propeller-type flying object of claim 1, wherein the leg plates protect the first and second fixing plates, the first and second protective plates, and the first and second adjustable propellers, and deliver wind to the first and second fixing plates and the first and second protective plates when the bottom-adjustable propeller-type flying object is landed on or taken off.

5. The bottom-adjustable propeller-type flying object of claim 1, wherein the first and second protective plates divide the wind generated downward by the rotation of the power propeller to allow the wind to pass therethrough, and protect the first and second adjustable propellers and the first and second adjusting meter motors.
